(19) United States
(12) Patent Application Publication
(10) Pub. No.: US 2026/0370155 A1
(43) Pub. Date: Nov. 19, 2026

(54) POWER CONVERSION DEVICE AND POWER CONVERSION DEVICE PROGRAM

(71) Applicant: Murata Manufacturing Co., Ltd., Kyoto-fu (JP)

(72) Inventors: Yuki ISHIKURA, Nagaokakyo-shi (JP); Chinmay BHAGAT, Nagaokakyo-shi (JP)

(73) Assignee: Murata Manufacturing Co., Ltd., Kyoto-fu (JP)

(21) Appl. No.: 19/745,459

(22) Filed: Jul. 17, 2026

Related U.S. Application Data
(63) Continuation of application No. PCT/JP2024/042038, filed on Nov. 27, 2024.

(30) Foreign Application Priority Data
Jan. 19, 2024 (JP) 2024-006759
Sep. 6, 2024 (JP) 2024-153638

(51) Int. Cl. H02M 7/23; H02M 1/00; H02M 1/084; H02M 1/32; H02M 3/335; H02M 7/217; H02M 7/219

(52) U.S. Cl. CPC H02M 7/23; H02M 1/007; H02M 1/084; H02M 1/325; H02M 3/33573; H02M 7/2173; H02M 7/219

(57) ABSTRACT

A power conversion device includes a first power conversion circuit, a second power conversion circuit, a transformer, and a controller. The first power conversion circuit can convert an input three-phase AC power and output the converted power from a pair of output terminals. The second power conversion circuit includes a switching circuit including a plurality of switch elements, a capacitor, and a pair of output terminals. The output terminals of the first power conversion circuit and the output terminals of the second power conversion circuit are connected to a primary winding of the transformer. The second power conversion circuit can output energy stored in the capacitor from the output terminals thereof.

### CROSS-REFERENCE TO RELATED APPLICATIONS

This application claims benefit of priority to International Patent Application No. PCT/JP2024/042038, filed Nov. 27, 2024, and to Japanese Patent Application No. 2024-153638, filed Sep. 6, 2024, and Japanese Patent Application No. 2024-006759, filed Jan. 19, 2024, the entire contents of each are incorporated herein by reference.

### BACKGROUND

### Technical Field

The present disclosure relates to a power conversion device and a power conversion device program.

### Background Art

A power conversion device disclosed in Japanese Unexamined Patent Application Publication No. 2019-68657 includes a plurality of nodes, six bidirectional switches, and a control device. Three of the plurality of nodes are input with three-phase AC power. The power conversion circuit is able to convert the three-phase AC power input to the nodes into DC power and output the DC power through on/off control of the bidirectional switches performed by the control device.

### SUMMARY

In a power conversion device such as the one disclosed in Japanese Unexamined Patent Application Publication No. 2019-68657, momentary power outages may occur in which the power supply to each node is momentarily interrupted. When such a momentary power outage occurs, there is a risk that the power conversion device will be unable to maintain power supply to the load.

Accordingly, the present disclosure provides a power conversion device including a first power conversion circuit, a transformer, a second power conversion circuit, and a controller. The first power conversion circuit includes a plurality of input terminals, a plurality of bidirectional switches, a first output terminal and a second output terminal, and is capable of converting three-phase AC power. The transformer includes a primary winding and a secondary winding, and a first end of the primary winding is connected to the first output terminal and a second end of the primary winding is connected to the second output terminal. The second power conversion circuit includes a capacitor, a plurality of switch elements, a third output terminal connected between the first output terminal and the first end of the primary winding, and a fourth output terminal connected between the second output terminal and the second end of the primary winding. The controller is capable of switching the plurality of bidirectional switches and the plurality of switch elements on and off. The second power conversion circuit is capable of outputting energy stored in the capacitor to the third output terminal and the fourth output terminal.

The present disclosure also provides a power conversion device program. The power conversion device program is to be applied to a power conversion device including a first power conversion circuit, a transformer, a second power conversion circuit, and a controller. The first power conversion circuit includes a plurality of input terminals, a plurality of bidirectional switches, a first output terminal and a second output terminal, and is capable of converting three-phase AC power. The transformer includes a primary winding and a secondary winding, and a first end of the primary winding is connected to the first output terminal and a second end of the primary winding is connected to the second output terminal. The second power conversion circuit includes a capacitor, a plurality of switch elements, a third output terminal connected between the first output terminal and the first end of the primary winding, and a fourth output terminal connected between the second output terminal and the second end of the primary winding. The controller is capable of switching the plurality of bidirectional switches and the plurality of switch elements on and off. The second power conversion circuit is capable of outputting the energy stored in the capacitor to the third output terminal and the fourth output terminal. The power conversion device program causes the controller to control the plurality of bidirectional switches so that the first power conversion circuit converts an input voltage and outputs the converted input voltage from the first output terminal and the second output terminal when an amplitude value of the input voltage input to one or more of the plurality of input terminals is greater than a predetermined threshold, and to control the plurality of bidirectional switches to an off state and to control the plurality of switch elements so that the energy stored in the capacitor is output to the primary winding from the third output terminal and the fourth output terminal when the amplitude value of the input voltage input to the plurality of input terminals is less than or equal to the threshold.

The present disclosure also provides a power conversion device including a first power conversion circuit, a second power conversion circuit, and a controller. The first power conversion circuit includes a plurality of input terminals, a first output terminal and a second output terminal, a plurality of bidirectional switches connecting the plurality of input terminals and the first output terminal and the second output terminal, a transformer having a primary winding and a secondary winding, with a first end of the primary winding connected to the first output terminal and a second end of the primary winding connected to the second output terminal, and a rectifier circuit connected to the secondary winding and capable of converting an AC voltage. The first power conversion circuit is capable of converting three-phase AC power input to the plurality of input terminals. The second power conversion circuit includes a capacitor, a plurality of switch elements, a third output terminal connected between the first output terminal and the first end of the primary winding, and a fourth output terminal connected between the second output terminal and the second end of the primary winding. The controller is capable of switching the plurality of bidirectional switches and the plurality of switch elements on and off. The second power conversion circuit is capable of outputting energy stored in the capacitor to the third output terminal and the fourth output terminal.

Even in the event of a momentary power outage, the power conversion device can maintain power supply to the load.

### BRIEF DESCRIPTION OF THE DRAWINGS

FIG. 1 is a circuit diagram of a power conversion device;

FIG. 2 is a circuit diagram of a first power conversion circuit;

FIG. 3 is a circuit diagram of a second power conversion circuit; and

FIG. 4 is a diagram illustrating the waveform and sectors of a three-phase AC voltage.

### DETAILED DESCRIPTION

### First Embodiment of Power Conversion Device and Power Conversion Device Program

Hereinafter, a First Embodiment of a power conversion device and a power conversion device program will be described. The drawings are merely illustrative of the embodiments of the present disclosure and should not be considered as limiting the present disclosure. Furthermore, the drawings are schematic diagrams intended to facilitate understanding and components may be depicted in an enlarged manner or omitted. Terms such as “first”, “second”, and “third” in the present disclosure are used solely to distinguish between objects and do not imply any ranking or order.

### Configuration of Power Conversion Device

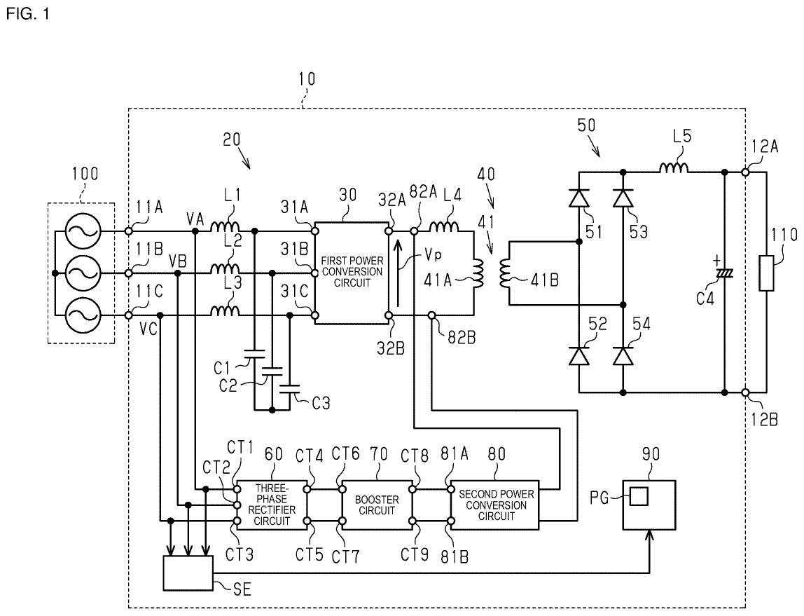

As illustrated in FIG. 1, a power conversion device 10 includes an input-side low pass filter 20, a first power conversion circuit 30, a transformer circuit 40, and a rectifier circuit 50. The power conversion device 10 further includes a first external input terminal 11A, a second external input terminal 11B, and a third external input terminal 11C, as well as a first external output terminal 12A and a second external output terminal 12B.

The power conversion device 10 is, as a whole, a so-called three-phase isolated AC-DC converter. That is, the power conversion device 10 converts three-phase AC power input to each external input terminal into DC power, which can then be output from a pair of external output terminals. The transformer circuit 40 is interposed on the path of power from the external input terminals to the external output terminals, thereby electrically isolating the external input terminals from the external output terminals.

For example, the three phases of the three-phase AC power input from a three-phase AC power supply 100 are input with a one-to-one correspondence to the external input terminals. The three-phase AC power supply 100 is a three-phase three-wire commercial power system in which three AC power supplies are connected in a Y configuration. The voltages of the three phases are a first voltage VA, a second voltage VB, and a third voltage VC. Each voltage is an AC voltage with a different phase from the other voltages. The first voltage VA is input to the first external input terminal 11A. The second voltage VB is input to the second external input terminal 11B. The third voltage VC is input to the third external input terminal 11C. The second voltage VB has a phase difference of 120° from the first voltage VA. The third voltage VC has a phase difference of 120° from the second voltage VB. Note that this “phase difference of 120°” allows for an error of approximately ±1°.

The pair of external output terminals consist of the first external output terminal 12A and the second external output terminal 12B. Any load 110 can be connected between the first external output terminal 12A and the second external output terminal 12B. The load 110 is, for example, an electronic device such as a server driven by DC power.

The input-side low pass filter 20 includes a first inductor L1, a second inductor L2, and a third inductor L3. The input-side low pass filter 20 also includes a first capacitor C1, a second capacitor C2, and a third capacitor C3.

A first end of the first inductor L1 is connected to the first external input terminal 11A. A first end of the first capacitor C1 is connected to a second end of the first inductor L1.

A first end of the second inductor L2 is connected to the second external input terminal 11B. A first end of the second capacitor C2 is connected to a second end of the second inductor L2. A second end of the second capacitor C2 is connected to a second end of the first capacitor C1.

A first end of the third inductor L3 is connected to the third external input terminal 11C. A first end of the third capacitor C3 is connected to a second end of the third inductor L3. A second end of the third capacitor C3 is connected to the second end of the first capacitor C1.

The first power conversion circuit 30 includes a plurality of input terminals and a pair of output terminals.

The plurality of input terminals of the first power conversion circuit 30 consist of a first input terminal 31A, a second input terminal 31B, and a third input terminal 31C. The first input terminal 31A is connected to the second end of the first inductor L1. The second input terminal 31B is connected to the second end of the second inductor L2. The third input terminal 31C is connected to the second end of the third inductor L3. Therefore, three-phase AC power is input to the input terminals of the first power conversion circuit 30 via the external input terminals and the input-side low pass filter 20. The pair of output terminals consist of a first output terminal 32A and a second output terminal 32B. Single-phase AC power converted by each element in the first power conversion circuit 30 is output from the pair of output terminals.

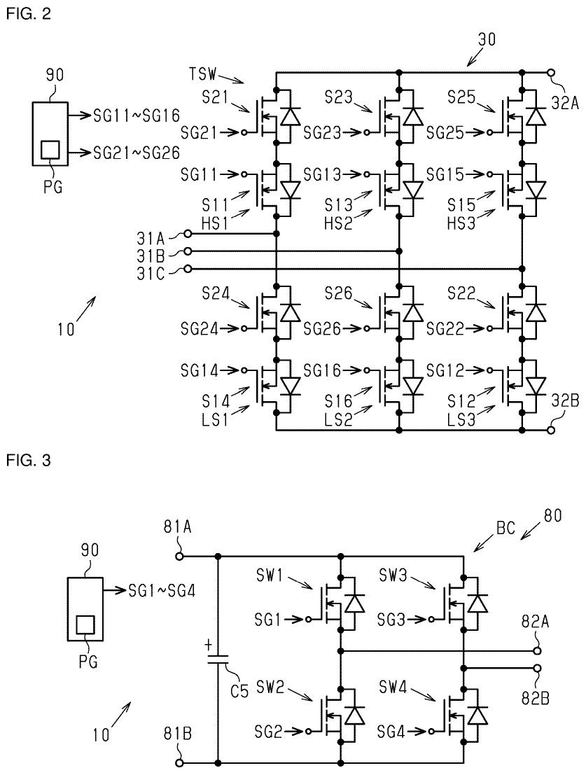

As illustrated in FIG. 2, the first power conversion circuit 30 includes a plurality of bidirectional switches TSW. Each bidirectional switch TSW includes two switch elements. Each switch element is an N-channel-type metal oxide semiconductor field effect transistor (MOSFET). In other words, each switch element includes a body diode. Each bidirectional switch TSW consists of two switch elements connected in series such that the anode terminals of the body diodes are connected to each other. That is, the switch elements that make up each bidirectional switch (TSW) are connected to each other such that the body diodes are oriented in opposite directions. In other words, each bidirectional switch TSW includes two switch elements with their source terminals connected to each other.

The plurality of bidirectional switches TSW consist of a first high-side bidirectional switch HS1, a first low-side bidirectional switch LS1, a second high-side bidirectional switch HS2, a second low-side bidirectional switch LS2, a third high-side bidirectional switch HS3, and a third low-side bidirectional switch LS3.

The first high-side bidirectional switch HS1 connects the first input terminal 31A and the first output terminal 32A to each other. Specifically, the first high-side bidirectional switch HS1 includes an 11th switch element S11 and a 21st switch element S21. The drain terminal of the 11th switch element S11 is connected to the first input terminal 31A. The source terminal of the 11th switch element S11 is connected to the source terminal of the 21st switch element S21. The drain terminal of the 21st switch element S21 is connected to the first output terminal 32A.

The first low-side bidirectional switch LS1 connects the first input terminal 31A and the second output terminal 32B to each other. Specifically, the first low-side bidirectional switch LS1 includes a 24th switch element S24 and a 14th switch element S14. The drain terminal of the 24th switch element S24 is connected to the first input terminal 31A. The source terminal of the 24th switch element S24 is connected to the source terminal of the 14th switch element S14. The drain terminal of the 14th switch element S14 is connected to the second output terminal 32B.

The second high-side bidirectional switch HS2 connects the second input terminal 31B and the first output terminal 32A to each other. Specifically, the second high-side bidirectional switch HS2 includes a 13th switch element S13 and a 23rd switch element S23. The drain terminal of the 13th switch element S13 is connected to the second input terminal 31B. The source terminal of the 13th switch element S13 is connected to the source terminal of the 23rd switch element S23. The drain terminal of the 23rd switch element S23 is connected to the first output terminal 32A.

The second low-side bidirectional switch LS2 connects the second input terminal 31B and the second output terminal 32B to each other. Specifically, the second low-side bidirectional switch LS2 includes a 26th switch element S26 and a 16th switch element S16. The drain terminal of the 26th switch element S26 is connected to the second input terminal 31B. The source terminal of the 26th switch element S26 is connected to the source terminal of the 16th switch element S16. The drain terminal of the 16th switch element S16 is connected to the second output terminal 32B.

The third high-side bidirectional switch HS3 connects the third input terminal 31C and the first output terminal 32A to each other. Specifically, the third high-side bidirectional switch HS3 includes a 15th switch element S15 and a 25th switch element S25. The drain terminal of the 15th switch element S15 is connected to the third input terminal 31C. The source terminal of the 15th switch element S15 is connected to the source terminal of the 25th switch element S25. The drain terminal of the 25th switch element S25 is connected to the first output terminal 32A.

The third low-side bidirectional switch LS3 connects the third input terminal 31C and the second output terminal 32B to each other. Specifically, the third low-side bidirectional switch LS3 includes a 22nd switch element S22 and a 12th switch element S12. The drain terminal of the 22nd switch element S22 is connected to the third input terminal 31C. The source terminal of the 22nd switch element S22 is connected to the source terminal of the 12th switch element S12. The drain terminal of the 12th switch element S12 is connected to the second output terminal 32B.

As illustrated in FIG. 1, the transformer circuit 40 includes a fourth inductor L4 and a transformer 41. The transformer 41 includes a primary winding 41A and a secondary winding 41B. A first end of the fourth inductor L4 is connected to the first output terminal 32A of the first power conversion circuit 30. A first end of the primary winding 41A is connected to a second end of the fourth inductor L4. A second end of the primary winding 41A is connected to the second output terminal 32B of the first power conversion circuit 30. The secondary winding 41B is connected to the pair of external output terminals via the rectifier circuit 50. The primary winding 41A and the secondary winding 41B are electrically isolated from each other.

The rectifier circuit 50 includes four diodes, a fifth inductor L5, and a fourth capacitor C4. The four diodes consist of a first diode 51, a second diode 52, a third diode 53, and a fourth diode 54.

The four diodes form a full bridge circuit. Specifically, the anode terminal of the first diode 51 is connected to a first end of the secondary winding 41B of the transformer 41. The cathode terminal of the first diode 51 is connected to the cathode terminal of the third diode 53. The anode terminal of the third diode 53 is connected to a second end of the secondary winding 41B and the cathode terminal of the fourth diode 54. The anode terminal of the fourth diode 54 is connected to the anode terminal of the second diode 52. The cathode terminal of the second diode 52 is connected to the first end of the secondary winding 41B and the anode terminal of the first diode 51.

A first end of the fifth inductor L5 is connected to the cathode terminal of the first diode 51 and the cathode terminal of the third diode 53. A second end of the fifth inductor L5 is connected to a first end of the fourth capacitor C4 and the first external output terminal 12A. A second end of the fourth capacitor C4 is connected to the anode terminal of the second diode 52 and the anode terminal of the fourth diode 54 and the second external output terminal 12B.

Therefore, the first diode 51 allows current to flow from the first end of the secondary winding 41B to the first external output terminal 12A. The fourth diode 54 allows current to flow from the second external output terminal 12B to the second end of the secondary winding 41B. The third diode 53 allows current to flow from the second end of the secondary winding 41B to the first external output terminal 12A. The second diode 52 allows current to flow from the second external output terminal 12B to the first end of the secondary winding 41B.

As illustrated in FIG. 1, the power conversion device 10 includes a three-phase rectifier circuit 60, a booster circuit 70, and a second power conversion circuit 80.

As illustrated in FIG. 1, the three-phase rectifier circuit 60 includes first to fifth connection terminals CT1 to CT5. The first connection terminal CT1 is connected to the first external input terminal 11A. The second connection terminal CT2 is connected to the second external input terminal 11B. The third connection terminal CT3 is connected to the third external input terminal 11C. Therefore, three-phase AC power is input from the three-phase AC power supply 100 to the first to third connection terminals CT1 to CT3 of the three-phase rectifier circuit 60. The three-phase rectifier circuit 60 converts the three-phase AC power into DC power using a plurality of rectifier diodes and inductors, which are not illustrated. The converted DC power is output from the fourth connection terminal CT4 and the fifth connection terminal CT5. The fourth connection terminal CT4 is a high-potential terminal, and the fifth connection terminal CT5 is a low-potential terminal.

The booster circuit 70 includes sixth to ninth connection terminals CT6 to CT9. The sixth connection terminal CT6 is connected to the fourth connection terminal CT4 of the three-phase rectifier circuit 60. The seventh connection terminal CT7 is connected to the fifth connection terminal CT5 of the three-phase rectifier circuit 60. Therefore, a DC voltage is input to the sixth connection terminal CT6 and the seventh connection terminal CT7. The booster circuit 70 boosts this DC voltage using switch elements, inductors, capacitors, etc., which are not illustrated, and outputs the boosted DC voltage. That is, the booster circuit 70 outputs DC power with a voltage value higher than that of the DC power input to the sixth connection terminal CT6 and the seventh connection terminal CT7 from the eighth connection terminal CT8 and the ninth connection terminal CT9. For example, if the effective value of the voltage of the three-phase AC power is 200 Vrms, the maximum value of each voltage of the three-phase AC power in this embodiment is approximately 283 V. Therefore, the output voltage of the booster circuit 70 is greater than 283 V. Note that the maximum value of the AC voltage is the effective value of the AC voltage multiplied by √2. Furthermore, the eighth connection terminal CT8 is a high-potential terminal, and the ninth connection terminal CT9 is a low-potential terminal.

The second power conversion circuit 80 includes a plurality of input terminals and a pair of output terminals. The plurality of input terminals of the second power conversion circuit 80 consist of a fourth input terminal 81A and a fifth input terminal 81B. The pair of output terminals of the second power conversion circuit 80 consist of a third output terminal 82A and a fourth output terminal 82B. The fourth input terminal 81A is connected to the eighth connection terminal CT8 of the booster circuit 70. The fifth input terminal 81B is connected to the ninth connection terminal CT9 of the booster circuit 70.

The third output terminal 82A is connected between the first output terminal 32A of the first power conversion circuit 30 and the first end of the fourth inductor L4. Therefore, the third output terminal 82A is connected to the first end of the primary winding 41A of the transformer 41 via the fourth inductor L4. In other words, the third output terminal 82A is connected between the first output terminal 32A and the first end of the primary winding 41A. The fourth output terminal 82B is connected to the second output terminal 32B of the first power conversion circuit 30 and the second end of the primary winding 41A of the transformer 41. Therefore, the fourth output terminal 82B is connected between the second output terminal 32B and the second end of the primary winding 41A.

As illustrated in FIG. 3, the second power conversion circuit 80 includes a fifth capacitor C5 and a switching circuit BC. A first end of the fifth capacitor C5 is connected to the fourth input terminal 81A. A second end of the fifth capacitor C5 is connected to the fifth input terminal 81B.

The switching circuit BC includes a first switch element SW1, a second switch element SW2, a third switch element SW3, and a fourth switch element SW4. The first to fourth switch elements SW1 to SW4 are n-channel type MOSFETs. The drain terminal of the first switch element SW1 is connected to the fourth input terminal 81A and the first end of the fifth capacitor C5. The drain terminal of the first switch element SW1 is connected to the drain terminal of the third switch element SW3. The source terminal of the first switch element SW1 is connected to the drain terminal of the second switch element SW2 and the third output terminal 82A. The source terminal of the third switch element SW3 is connected to the fourth output terminal 82B and the drain terminal of the fourth switch element SW4. The source terminal of the fourth switch element SW4 is connected to the fifth input terminal 81B and the source terminal of the second switch element SW2.

As illustrated in FIG. 1, the power conversion device 10 includes a power sensor SE and a controller 90. The power sensor SE is capable of detecting the power applied to the first external input terminal 11A, the second external input terminal 11B, and the third external input terminal 11C. Specifically, the power sensor SE is capable of detecting the voltage and current values input to each external input terminal. In other words, the power sensor SE is capable of detecting the first voltage VA, the second voltage VB, and the third voltage VC.

The controller 90 includes a storage device and an execution device, which are not illustrated. That is, the controller 90 is a microcontroller unit (MCU) The storage device of the controller 90 stores a program PG that is executed by the execution device.

The execution device is, for example, a central processing unit (CPU), a micro processing unit (MPU), a field programmable gate array (FPGA), or a complex programmable logic device (CPLD), an application specific integrated circuit (ASIC), etc. The execution device of the controller 90 can execute first control and second control described later by executing the program PG.

Specifically, the program PG contains data for executing the first control and the second control. As part of this data, the program PG defines a plurality of different switching patterns for the plurality of bidirectional switches TSW in the first power conversion circuit 30. These switching patterns define combinations of on/off states for the plurality of bidirectional switches TSW. Furthermore, the program PG defines the order in which the switching patterns for the bidirectional switches TSW are switched.

The power conversion device 10 includes a gate driving circuit, which is not illustrated. The gate driving circuit switches the on/off state of the two switch elements of each bidirectional switch TSW, and the first to fourth switch elements SW1 to SW4. The execution device of the controller 90 controls each switch element by inputting a switching signal to the input terminal of the gate driving circuit and outputting a gate drive voltage to each switch element via the gate driving circuit.

As illustrated in FIG. 2, the switching signals include 11th to 16th switching signals SG11 to SG16 and 21st to 26th switching signals SG21 to SG 26. The 11th to 16th switching signals SG11 to SG16 have a one-to-one correspondence with the 11th to 16th switch elements S11 to S16. The 21st to 26th switching signals SG21 to SG 26 have a one-to-one correspondence with the 21st to 26th switch elements S21 to S26.

The execution device of the controller 90 controls the on/off states of the plurality of bidirectional switches TSW by switching the switching pattern in accordance with a plurality of switching patterns. As a result, the first power conversion circuit 30 converts the three-phase AC power input to each input terminal into AC power and outputs the converted AC power. That is, as illustrated in FIG. 1, when the potential difference at the first output terminal 32A with respect to the second output terminal 32B of the first power conversion circuit 30 is defined as a primary voltage Vp, the primary voltage Vp is an AC voltage. Therefore, the primary voltage Vp, which is an AC voltage, is applied to the primary winding 41A of the transformer 41.

As illustrated in FIG. 3, the switching signals include first to fourth switching signals SG1 to SG4. The first to fourth switching signals SG1 to SG4 have a one-to-one correspondence with the first to fourth switch elements SW1 to SW4. As a result, the second power conversion circuit 80 can convert the DC power discharged from the fifth capacitor C5 into AC power using control described later.

### Control in Event of Voltage Anomaly

When power supply to each external input terminal of the power conversion device 10 is started, the execution device of the controller 90 executes the first control and the second control, etc., based on the program PG described above. In the following description, control performed by the execution device of the controller 90 will be simply referred to as control performed by the controller 90.

When the program PG is started, the controller 90 first turns off the first to fourth switch elements SW1 to SW4. While the program PG is running, the controller 90 acquires the voltage values of the three-phase AC power input to the external input terminals detected by the power sensor SE. The controller 90 then acquires the voltage values of the first input terminal 31A, the second input terminal 31B, and the third input terminal 31C in the first power conversion circuit 30 through the voltage values of the external input terminals of the power conversion device 10. Furthermore, the controller 90 determines whether the amplitude values of the input voltages input to the plurality of input terminals are less than or equal to a predetermined first threshold. In this embodiment, the controller 90 determines whether the amplitude values of the input voltages input to all input terminals, including the first input terminal 31A, the second input terminal 31B, and the third input terminal 31C, are less than or equal to the predetermined first threshold. This first threshold is, for example, 1/20√2 of the amplitude value of the AC voltage when the three-phase AC power supply 100 is operating normally. In this embodiment, the amplitude values of the first to third voltages VA to VC input from the three-phase AC power supply 100 are 200√2 (approximately 283) V. Therefore, the predetermined value is 10 V. For example, if a momentary power outage occurs in which the power supplied to the power conversion device 10 is interrupted for several tens of milliseconds, the amplitude values of each input voltage may all simultaneously become 10 V or less.

Here, the amplitude value refers to the wavelength height of an AC waveform during one cycle. That is, the amplitude value is a value that fluctuates during the operation of the power conversion device 10. For example, when the three-phase AC power supply 100 is operating normally, the amplitude values of the first to third voltages VA to VC are 200√2V. If a momentary power outage occurs, these voltages will decrease, and therefore the amplitude values may decrease. The amplitude value is sometimes also called the peak value. Alternatively, the amplitude value may be calculated by dividing the difference between the maximum and minimum values during one cycle of the AC waveform by two.

The controller 90 executes the first control if the amplitude values of the input voltages input to all the input terminals are not less than or equal to the predetermined first threshold, in other words, if the amplitude values of the input voltages input to one or more input terminals among the first to third input terminals 31A to 31C are greater than the predetermined first threshold. In the first control, the controller 90 controls the first to fourth switch elements SW1 to SW4 so that no voltage is applied from the first output terminal 32A and the second output terminal 32B to the fifth capacitor C5. That is, the controller 90 controls the plurality of switch elements so that the fifth capacitor C5 and each output terminal of the first power conversion circuit 30 do not conduct electricity through the first to fourth switch elements SW1 to SW4.

Specifically, in the first control, the controller 90 maintains the first to fourth switch elements SW1 to SW4 in the off state if the amplitude value of one or more input voltages among the first voltage VA, the second voltage VB, and the third voltage VC detected by the power sensor SE is greater than the first threshold. At this time, the controller 90 controls the on/off state of each bidirectional switch TSW of the first power conversion circuit 30 by switching the switching pattern in accordance with the switching patterns defined in the program PG. In other words, in this case, the first power conversion circuit 30 converts the three-phase AC voltage consisting of the first voltage VA to the third voltage VC into single-phase AC power. The converted AC voltage is then output from the first output terminal 32A and the second output terminal 32B and applied to the primary winding 41A of the transformer 41. Furthermore, this AC voltage is not applied to the fifth capacitor C5 of the second power conversion circuit 80.

Furthermore, if the amplitude value of one or more input voltages among the first voltage VA to the third voltage VC is greater than the first threshold, the three-phase AC power input from the three-phase AC power supply 100 to the power conversion device 10 is converted to DC power of a predetermined voltage value via the three-phase rectifier circuit 60 and the booster circuit 70. This DC power is then used to charge the fifth capacitor C5 of the second power conversion circuit 80. Note that, due to the presence of the booster circuit 70, the power charged to the fifth capacitor C5 is greater than the maximum value of the voltage of the three-phase AC power. That is, if the RMS voltage of the three-phase AC power is 200 Vrms, the maximum terminal voltage of the fifth capacitor C5 is greater than 283 V.

The controller 90 executes the second control when the amplitude values of all input voltages, from the first voltage VA to the third voltage VC, detected by the power sensor SE, are simultaneously less than or equal to the first threshold. In the second control, the controller 90 switches all of the plurality of bidirectional switches TSW to the off state at a timing when the primary voltage Vp becomes less than or equal to a predetermined second threshold. Furthermore, the controller 90 controls the first to fourth switch elements SW1 to SW4 according to a predetermined pattern so that the energy stored in the fifth capacitor C5 is output to the primary winding 41A. In this embodiment, all bidirectional switches TSW are switched to the off state at the above timing. The second threshold is 10 V. Note that “simultaneously” allows for an error of several milliseconds.

Specifically, as described above, the output voltage of the first power conversion circuit 30 is an AC voltage. That is, the primary voltage Vp periodically alternates between a positive state, a near-zero volt state, and a negative state. The controller 90 switches all the bidirectional switches TSW to the off state when the primary voltage Vp is in the near-zero volt state. The controller 90 then controls each switch element so that the DC power discharged from the fifth capacitor C5 is converted into AC power, and so that this AC power is output from the third output terminal 82A and the fourth output terminal 82B. In other words, the controller 90 controls each switch element so that an AC voltage is applied from the output terminals of the second power conversion circuit 80 to the primary winding 41A of the transformer 41.

More specifically, when the primary voltage Vp is negative, if the amplitude values of the input voltages input to all input terminals simultaneously become less than or equal to the first threshold, the controller 90 switches all the bidirectional switches TSW to the off state at a timing when the absolute value of the primary voltage Vp becomes less than or equal to the predetermined second threshold. Furthermore, the controller 90 controls the first to fourth switch elements SW1 to SW4 so that the primary voltage Vp changes to the positive side when the energy stored in the fifth capacitor C5 begins to be output.

Furthermore, when the primary voltage Vp is positive, if the amplitude values of the input voltages input to all of the input terminals simultaneously become less than or equal to the first threshold, the controller 90 switches all bidirectional switches TSW to the off state at a timing when the absolute value of the primary voltage Vp becomes less than or equal to the predetermined second threshold. Moreover, the controller 90 controls the first to fourth switch elements SW1 to SW4 so that the primary voltage Vp changes to the negative side when the energy stored in the fifth capacitor C5 begins to be output.

Thus, when the amplitudes of all input voltages from the first voltage VA to the third voltage VC detected by the power sensor SE simultaneously become less than or equal to the first threshold, the controller 90 turns all the bidirectional switches TSW off and controls each switch element of the switching circuit BC in accordance with a predetermined switching pattern. In this state, the controller 90 determines whether the amplitude value of the input voltage input to one or more input terminals among the first to third input terminals 31A to 31C is greater than the predetermined first threshold. Specifically, the controller 90 determines whether the amplitude value of one or more input voltages from the first voltage VA to the third voltage VC detected by the power sensor SE is greater than the first threshold.

Let us suppose that after the amplitude values of all input voltages from the first voltage VA to the third voltage VC detected by the power sensor SE simultaneously became less than or equal to the first threshold as described above, the amplitude value of one or more input voltages from the first voltage VA to the third voltage VC becomes greater than the first threshold. In this case, the controller 90 executes the first control again. That is, the controller 90 controls the first to fourth switch elements SW1 to SW4 so that the first output terminal 32A and the second output terminal 32B and the fifth capacitor C5 do not conduct electricity through the switching circuit BC. Specifically, the controller 90 switches all of the first to fourth switch elements SW1 to SW4 to the off state. After that, the controller 90 controls the plurality of bidirectional switches TSW of the first power conversion circuit 30 again by switching the switching pattern defined in the program PG. In other words, the controller 90 switches any one of the bidirectional switches TSW to the on state in accordance with a predetermined switching pattern. Therefore, for example, when power supply from the three-phase AC power supply 100 is restored after a momentary power outage, the controller 90 switches from power conversion performed by the second power conversion circuit 80 to power conversion performed by the first power conversion circuit 30.

### Operation of This Embodiment

The power conversion device 10 of the above embodiment is configured as a so-called single-stage converter. That is, the first power conversion circuit 30 converts three-phase AC power to AC power using six bidirectional switches TSW. Then, the transformer circuit 40 and the rectifier circuit 50 convert this AC power to DC power. The power conversion device 10 configured as a single-stage converter has a higher power conversion efficiency than a power conversion device configured as a so-called two-stage converter. Furthermore, because capacitors are not provided between stages like in a two-stage configuration, the power conversion device 10 with a single-stage configuration as in the above embodiment has a relatively high power density.

On the other hand, a power conversion circuit with a single-stage configuration, such as the first power conversion circuit 30 in the above embodiment, does not include an energy storage mechanism such as a capacitor. Therefore, with only the first power conversion circuit 30, there is a risk that it might not be possible to maintain the output voltage within a predetermined range in the event of a momentary power outage. According to the above embodiment, the power conversion device 10 includes the second power conversion circuit 80 including the fifth capacitor C5 in addition to the first power conversion circuit 30. Therefore, even with the power conversion device 10 having a single-stage configuration, there is a high possibility that power supply to the load 110 can be maintained in the event of a momentary power outage.

Furthermore, the controller 90 executes the first control if the amplitude value of one or more input voltages among the first voltage VA, the second voltage VB, and the third voltage VC detected by the power sensor SE is greater than the first threshold. In this first control, the controller 90 maintains the first to fourth switch elements SW1 to SW4 in the off state. Therefore, in this case, the fifth capacitor C5 of the second power conversion circuit 80 and the primary winding 41A of the transformer 41 are electrically disconnected. Also in this case, the controller 90 controls the on/off state of each bidirectional switch TSW of the first power conversion circuit 30 in order to allow the first power conversion circuit 30 to function.

The controller 90 executes the second control when the amplitude values of a plurality of input voltages, from the first voltage VA to the third voltage VC, detected by the power sensor SE, simultaneously become less than or equal to the first threshold. In this second control, the controller 90 switches the plurality of bidirectional switches TSW to the off state. The controller 90 then controls the first to fourth switch elements SW1 to SW4 in accordance with a predetermined pattern. As a result, the second power conversion circuit 80 can apply an AC voltage to the primary winding 41A using the energy charged to the fifth capacitor C5 as a power source. In other words, the second power conversion circuit 80 functions as a backup power supply capable of supplying power to the load 110 even in the event of a momentary power outage.

Furthermore, if, after performing the above control, the controller 90 determines that the amplitude value of one or more input voltages among the first voltage VA, the second voltage VB, and the third voltage VC exceeds the first threshold, the controller 90 performs the first control again. At this time, the controller 90 switches each switch element of the switching circuit BC to the off state before resuming control of the first power conversion circuit 30. In other words, once power supply from the three-phase AC power supply 100 is restored, the controller 90 controls each switch element of the switching circuit BC so that the voltage output from each output terminal of the first power conversion circuit 30 is not applied to the fifth capacitor C5 of the second power conversion circuit 80. Therefore, with this control, the possibility of the output voltage of the first power conversion circuit 30 being applied to the fifth capacitor C5 is low. That is, it is possible to prevent an unintended large current from flowing through the fifth capacitor C5.

### Effects of First Embodiment

(1-1) In the First Embodiment described above, the pair of output terminals of the second power conversion circuit 80 are connected to the primary winding 41A of the transformer 41. The controller 90 controls the on/off states of the first to fourth switch elements SW1 to SW4, thereby enabling the second power conversion circuit 80 to output the energy stored in the fifth capacitor C5. This increases the likelihood that the power conversion device 10 can output the designed output voltage even in the event of a momentary power outage.
(1-2) In the First Embodiment described above, when the amplitude values of the input voltages input to the plurality of input terminals become less than or equal to the first threshold, the controller 90 switches the plurality of bidirectional switches TSW to the off state. Furthermore, the controller 90 controls the plurality of switch elements of the switching circuit BC so that the energy stored in the fifth capacitor C5 is output to the primary winding 41A. This ensures that, even if a momentary power outage occurs, power can continue to be supplied to the load 110 using the fifth capacitor C5 as a power source. In addition, by switching the plurality of bidirectional switches TSW to the off state, it is possible to prevent an unintended current such as an in-rush current from flowing to the fifth capacitor C5 when the power supply from the three-phase AC power supply 100 is restored.
(1-3) If the control of the first power conversion circuit 30 is switched to the control of the second power conversion circuit 80 when the primary voltage Vp is not near zero, a difference is likely to occur between the time when the primary voltage Vp is positive and the time when the primary voltage Vp is negative. This can cause a magnetic bias phenomenon in the primary winding 41A, which may lead to magnetic saturation in the transformer 41. When magnetic saturation occurs, the primary current increases sharply, which may reduce the power conversion efficiency of the transformer 41 or cause an excessive electrical load on elements in the first power conversion circuit 30.

According to the configuration of the First Embodiment described above, when the primary voltage Vp is near zero, the controller 90 switches the plurality of bidirectional switches TSW to the off state and controls each switch element of the switching circuit BC so that the energy stored in the fifth capacitor C5 is output to the primary winding 41A. Therefore, with this configuration, even when the bidirectional switches TSW and each switch element are controlled as described above, it is possible to suppress a situation in which either the time during which the primary voltage Vp is positive or the time during which the primary voltage Vp is negative becomes excessively long. As a result, the magnetic bias phenomenon is less likely to occur, and the adverse effects associated with the magnetic bias phenomenon described above can be prevented.
(1-4) In the First Embodiment described above, if a momentary power outage occurs when the primary voltage Vp is negative, the controller 90 controls the bidirectional switches TSW so that the primary voltage Vp becomes near zero, and then switches the plurality of bidirectional switches TSW to the off state. Next, the controller 90 controls each switch element of the switching circuit BC so that the second power conversion circuit 80 outputs a positive voltage. Also, if a momentary power outage occurs when the primary voltage Vp is positive, the controller 90 controls the bidirectional switches TSW so that the primary voltage Vp becomes near zero, and then switches the plurality of bidirectional switches TSW to the off state. Next, the controller 90 controls each switch element of the switching circuit BC so that the second power conversion circuit 80 outputs a negative voltage. As a result, the magnetic bias phenomenon is less likely to occur, and the power conversion efficiency of the transformer 41 is less likely to decrease.
(1-5) In the First Embodiment described above, after the power input from the three-phase AC power supply 100 is restored, the controller 90 disconnects the electrical connection between the fifth capacitor C5 of the second power conversion circuit 80 and the output terminals of the first power conversion circuit 30, and then controls the bidirectional switches TSW of the first power conversion circuit 30. This prevents an unintended current, such as an in-rush current, from flowing from the first power conversion circuit 30 to the fifth capacitor C5 of the second power conversion circuit 80.
(1-6) In the First Embodiment described above, even if power conversion performed by the first power conversion circuit 30 is stopped for overvoltage protection or overcurrent protection of the output voltage, the controller 90 controls the first to fourth switch elements SW1 to SW4 so that the current flowing through the transformer 41 flows to the second power conversion circuit 80. In other words, the second power conversion circuit 80 functions as a protection circuit for the first power conversion circuit 30.
(1-7) As described above, the second power conversion circuit 80 also functions as a protection circuit and a backup power supply circuit. Therefore, the power conversion device 10 is unlikely to be large in size.
(1-8) In so-called data centers, three-phase isolated AC-DC converters are sometimes used to supply power to equipment such as server computers. Such three-phase isolated AC-DC converters may include a backup power supply to ensure continuous power supply to servers, etc., even in the event of a momentary power outage. Such three-phase isolated AC-DC converters may also include a protection circuit to suppress electrical loads on the switch elements, such as overvoltage and overcurrent. However, if both a backup power supply and a protection circuit are installed in a three-phase isolated AC-DC converter, there is a risk that the device will be increased in size. In the power conversion device 10 of the First Embodiment described above, the second power conversion circuit 80 combines the functions of a protection circuit and a backup power supply circuit, and therefore the power conversion device 10 is unlikely to become larger in size. Therefore, the power conversion device 10 of the above embodiment is suitable as a three-phase isolated AC-DC converter for supplying power to a server computer, etc., as the load 110.

### Second Embodiment of Power Conversion Device and Power Conversion Device Program

Hereinafter, a Second Embodiment of a power conversion device and a power conversion device program will be described. The circuit configuration of the power conversion device in the Second Embodiment is the same as in the First Embodiment. The Second Embodiment differs from the First Embodiment mainly in that transition control is performed between the first control and the second control.

### Definition of Sectors

In the Second Embodiment, one cycle of the AC voltage input to each input terminal of the first power conversion circuit 30 is divided into multiple sectors based on the relative magnitudes of the first voltage VA, the second voltage VB, and the third voltage VC. In the Second Embodiment, these sectors are defined as follows.

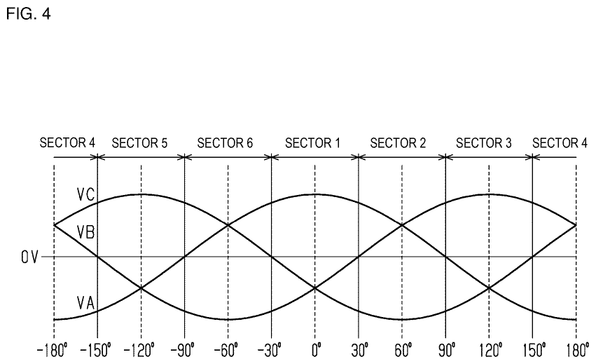

Three-phase AC power is input to the input terminals of the first power conversion circuit 30 from the three-phase AC power supply 100 via the input-side low pass filter 20. As illustrated in FIG. 4, the voltages of the three phases of this three-phase AC power are the first voltage VA, the second voltage VB, and the third voltage VC, which are AC voltages with different phases from each other. The voltages are input to the first input terminal 31A, the second input terminal 31B, and the third input terminal 31C with a one-to-one correspondence. Specifically, the first voltage VA is input to the first input terminal 31A. The second voltage VB is input to the second input terminal 31B. The third voltage VC is input to the third input terminal 31C. The second voltage VB has a phase difference of 120° from the first voltage VA. The third voltage VC has a phase difference of 120° from the second voltage VB.

Here, the timing of the phase when the first voltage VA is maximum is defined as 0°. The timing of the phase when the first voltage VA is minimum is defined as −180°. Therefore, one period of the first voltage VA, the second voltage VB, and the third voltage VC is expressed in the phase range of −180° or more and less than 180°. It is also possible to express the voltage phase timing in terms of phases from 180° or more and less than 360°. When the voltage phase is expressed in terms of a phase of 180° or more, X° is equivalent to (−180°+(X−180°)). Here, sectors 1 to 6 are defined as periods obtained by dividing the period of this one cycle into six equal parts. Specifically, when the phase of the first voltage VA is “θ°”, sectors 1 to 6 are defined as periods with 60° intervals as follows.
Sector 1: −30°≤θ°<30°
Sector 2: 30°≤θ°<90°
Sector 3: 90°≤θ°<150°
Sector 4: 150°≤θ°<180° and −180°≤θ°<−150°
Sector 5: −150°≤θ°<−90°
Sector 6: −90°≤θ°<−30°

However, the boundary of each sector may belong to either sector. For example, in the following example, when θ°=30°, the angle can be treated as belonging to either sector 1 or sector 2.

Thus, sector 1 is the period in which the first voltage VA is positive, the absolute value of the first voltage VA is greater than or equal to the absolute value of the second voltage VB, and the absolute value of the first voltage VA is greater than or equal to the absolute value of the third voltage VC. Sector 2 is the period in which the third voltage VC is negative, the absolute value of the third voltage VC is greater than or equal to the absolute value of the first voltage VA, and the absolute value of the third voltage VC is greater than or equal to the absolute value of the second voltage VB. Sector 3 is the period in which the second voltage VB is positive, the absolute value of the second voltage VB is greater than or equal to the absolute value of the first voltage VA, and the absolute value of the second voltage VB is greater than or equal to the absolute value of the third voltage VC. Sector 4 is the period in which the first voltage VA is negative, the absolute value of the first voltage VA is greater than or equal to the absolute value of the second voltage VB, and the absolute value of the first voltage VA is greater than or equal to the absolute value of the third voltage VC. Sector 5 is the period in which the third voltage VC is positive, the absolute value of the third voltage VC is greater than or equal to the absolute value of the first voltage VA, and the absolute value of the third voltage VC is greater than or equal to the absolute value of the second voltage VB. Sector 6 is the period in which the second voltage VB is negative, the absolute value of the second voltage VB is greater than or equal to the absolute value of the first voltage VA, and the absolute value of the second voltage VB is greater than or equal to the absolute value of the third voltage VC.

Thus, in sectors 1 and 4, the absolute value of the first voltage VA is the largest. In sectors 2 and 5, the absolute value of the third voltage VC is the largest. In sectors 3 and 6, the absolute value of the second voltage VB is the largest.

### Control in Event of Voltage Anomaly

The storage device of the controller 90 stores the program PG that includes data for executing transition control, in addition to data for executing the first control and the second control in the First Embodiment. When power supply to each external input terminal of the power conversion device 10 is started, the execution device of the controller 90 executes the first control and the second control, etc., based on the program PG described above. In the Second Embodiment, the controller 90 also executes transition control between the first control and the second control based on the program PG. In the following description, even if a switch element that was originally in the on state is maintained in the on state, it may be described as being switched to the on state. The same applies to the off state of the switch elements.

The controller 90 executes the first control if the amplitude values of the input voltages input to all the input terminals are not less than or equal to the predetermined first threshold, in other words, if the amplitude values of the input voltages input to one or more input terminals among the first to third input terminals 31A to 31C are greater than the predetermined first threshold. The specific control mode of the controller 90 in the first control is substantially the same as in the First Embodiment. That is, the controller 90 controls the bidirectional switches TSW of the first power conversion circuit 30 so that AC power is output from the first output terminal 32A and the second output terminal 32B.

If, during the execution of the first control, all the input voltages from the first voltage VA to the third voltage VC detected by the power sensor SE simultaneously become less than or equal to the first threshold, the controller 90 executes transition control prior to the second control.

The transition control consists of three processes, namely, a first process, a second process, and a third process.

When executing the first process, the controller 90 first determines which sector contains the phase at which the amplitude values of all input voltages from the first voltage VA to the third voltage VC simultaneously become less than or equal to the first threshold, i.e., the phase at which the transition control was initiated. Subsequently, the controller 90 controls the on/off state of the plurality of bidirectional switches TSW so that a closed circuit is formed from the first end of the primary winding 41A to the second end of the primary winding 41A through any one of the plurality of bidirectional switches TSW of the first power conversion circuit 30. Note that the expression “from the first end to the second end of the primary winding 41A” describes the path of electrical conduction and does not describe the direction of current flow. At this time, the controller 90 changes the on/off combination of the bidirectional switches TSW depending on which sector contains the phase at which the transition control was initiated.

Specifically, let us assume a case where the phase when the transition control was initiated is contained within the range of sector 1 or sector 4. In this case, in the first process, the controller 90 switches all of the 11th switch element S11, the 21st switch element S21, the 24th switch element S24, and the 14th switch element S14, among the switch elements of the first power conversion circuit 30, to the on state. This forms a closed circuit that extends from the first end of the primary winding 41A to the second end of the primary winding 41A through the fourth inductor L4, the 21st switch element S21, the 11th switch element S11, the 24th switch element S24, and the 14th switch element S14. At this time, the controller 90 maintains the on/off states of the 13th switch element S13, the 23rd switch element S23, the 26th switch element S26, and the 16th switch element S16 as the on/off states that were present when the transition control was initiated. Similarly, the controller 90 maintains the on/off states of the 15th switch element S15, the 25th switch element S25, the 22nd switch element S22, and the 12th switch element S12 as the on/off states that were present when the transition control was initiated. In other words, the on/off state of each switch element is maintained without being changed for the bidirectional switches TSW connected to the second input terminal 31B and the bidirectional switches TSW connected to the third input terminal 31C.

Furthermore, let us assume a case where the phase when the transition control was initiated is contained within the range of sector 2 or sector 5. In this case, in the first process, the controller 90 switches all of the 15th switch element S15, the 25th switch element S25, the 22nd switch element S22, and the 12th switch element S12, among the switch elements of the first power conversion circuit 30, to the on state. This forms a closed circuit that extends from the first end of the primary winding 41A to the second end of the primary winding 41A through the fourth inductor L4, the 25th switch element S25, the 15th switch element S15, the 22nd switch element S22, the 12th switch element S12. At this time, the controller 90 maintains the on/off states of the 11th switch element S11, the 21st switch element S21, the 24th switch element S24, and the 14th switch element S14 as the on/off states that were present when the transition control was initiated. Similarly, the controller 90 maintains the on/off states of the 13th switch element S13, the 23rd switch element S23, the 26th switch element S26, and the 16th switch element S16 as the on/off states that were present when the transition control was initiated. In other words, the on/off state of each switch element is maintained without being changed for the bidirectional switches TSW connected to the first input terminal 31A and the bidirectional switches TSW connected to the second input terminal 31B.

Furthermore, let us assume a case where the phase when the transition control was initiated is contained within the range of sector 3 or sector 6. In this case, in the first process, the controller 90 switches all of the 13th switch element S13, the 23rd switch element S23, the 26th switch element S26, and the 16th switch element S16, among the switch elements of the first power conversion circuit 30, to the on state. This forms a closed circuit that extends from the first end of the primary winding 41A to the second end of the primary winding 41A through the fourth inductor L4, the 23rd switch element S23, the 13th switch element S13, the 26th switch element S26, and the 16th switch element S16. At this time, the controller 90 maintains the on/off states of the 11th switch element S11, the 21st switch element S21, the 24th switch element S24, and the 14th switch element S14 as the on/off states that were present when the transition control was initiated. Similarly, the controller 90 maintains the on/off states of the 15th switch element S15, the 25th switch element S25, the 22nd switch element S22, and the 12th switch element S12 as the on/off states that were present when the transition control was initiated. In other words, the on/off state of each switch element is maintained without being changed for the bidirectional switches TSW connected to the first input terminal 31A and the bidirectional switches TSW connected to the third input terminal 31C.

On the other hand, regardless of which sector range contains the phase when the transition control was initiated, the controller 90 turns all of the first to fourth switch elements SW1 to SW4 of the second power conversion circuit 80 off in the first process. Before executing the first process of the transition control, the controller 90 is executing the first control. As described above, the controller 90 maintains the first to fourth switch elements SW1 to SW4 in the off state in the first control. Therefore, in the first process, the controller 90 maintains the on/off states of the first to fourth switch elements SW1 to SW4 in the off state.

Once the switching of each switch element according to the first process is complete, the controller 90 then executes the second process. When executing the second process, the controller 90 maintains the on/off state of each bidirectional switch TSW of the first power conversion circuit 30 as the state that was present after the first process. When executing the second process, the controller 90 controls the on/off states of the plurality of switch elements so that a closed circuit is formed from the first end of the primary winding 41A to the second end of the primary winding 41A through any one of the plurality of switch elements of the second power conversion circuit 80. Specifically, the controller 90 switches the second switch element SW2 and the fourth switch element SW4 of the second power conversion circuit 80 to the on state. The controller 90 also maintains the first switch element SW1 and the third switch element SW3 of the second power conversion circuit 80 in the off state. As a result, a closed circuit is formed from the first end of the primary winding 41A to the second end of the primary winding 41A through the fourth inductor L4, the second switch element SW2, and the fourth switch element SW4.

Once the switching of each switch element according to the second process is complete, the controller 90 then executes the third process. When executing the third process, the controller 90 switches all of the plurality of bidirectional switches TSW of the first power conversion circuit 30 to the off state. More specifically, the controller 90 switches all of the switch elements included in the first power conversion circuit 30 to the off state. In addition, when executing the third process, the controller 90 maintains the on/off state of each switch element of the second power conversion circuit 80 in the state that was present after switching in the second process.

As described above, when transition control is executed from the state in which the first control is being executed, the controller 90 executes the above three processes in the order of the first process, the second process, and the third process during the transition control.

When the third process is completed, i.e., the transition control is completed, the controller 90 executes the second control. The specific control mode of the controller 90 in the second control is substantially the same as in the First Embodiment. That is, the controller 90 controls each switch element of the second power conversion circuit 80 so that AC power is output from the third output terminal 82A and the fourth output terminal 82B. In the second control, all of the bidirectional switches TSW of the first power conversion circuit 30 are maintained in the off state. Therefore, in the second control, the state to which each bidirectional switch TSW of the first power conversion circuit 30 was switched in the third process of the transition control is maintained in the second control as well.

If, during the execution of the second control, the controller 90 determines that the amplitude value of one or more input voltages among the first to third voltages VA to VC exceeds the first threshold, the controller 90 will execute the transition control again. If the transition control is executed while the second control is being executed, the controller 90 will execute the three processes described above in the transition control in the order of the third process, the second process, and the first process.

If the transition control is executed immediately after the second control, the controller 90 determines which sector contains the phase when the controller 90 switches to the first control after terminating the transition control. The controller 90 can determine the timing at which the transition control is terminated from the time required for the third process, the second process, and the first process of the transition control. The controller 90 then changes the on/off combination of the bidirectional switches TSW in the second process and the first process depending on which sector contains the phase at which the transition control is terminated.

Specifically, let us suppose the phase when the transition control is terminated is within the range of sector 1 or sector 4. In this case, the controller 90 sets the on/off states of the bidirectional switches TSW to the same combination as when the phase at the time of initiating the transition control, in the case where the first process of the transition control is executed immediately following the first control, is within the range of sector 1 or sector 4. Furthermore, let us suppose that the phase when the transition control is terminated is within the range of sector 2 or sector 5. In this case, the controller 90 sets the on/off states of the bidirectional switches TSW to the same combination as when the phase at the time of initiating the transition control, in the case where the first process of the transition control is executed immediately following the first control, is within the range of sector 2 or sector 5. In addition, let us suppose that the phase when the transition control is terminated is within the range of sector 3 or sector 6. In this case, the controller 90 sets the on/off states of the bidirectional switches TSW to the same combination as when the phase at the time of initiating the transition control, in the case where the first process of the transition control is executed immediately following the first control, is within the range of sector 3 or sector 6.

### Effects of Second Embodiment

The power conversion device 10 of the Second Embodiment provides the following effects in addition to the effects (1-1), (1-2), and (1-5) to (1-8) of the power conversion device 10 of the First Embodiment.
(2-1) While the controller 90 is performing the first control, the power supply from the three-phase AC power supply 100 may be momentarily interrupted. In this case, the on/off state of each bidirectional switch TSW may be switched even though the absolute value of the primary voltage Vp is not below the second threshold, which may cause magnetic saturation in the transformer 41.

In the Second Embodiment described above, the controller 90 performs transition control between the first control and the second control. In the second process of this transition control, a closed circuit is formed from the first end of the primary winding 41A to the second end of the primary winding 41A through any one of the plurality of bidirectional switches TSW of the first power conversion circuit 30. Simultaneously, a closed circuit is formed from the first end of the primary winding 41A to the second end of the primary winding 41A through any one of the plurality of switch elements of the second power conversion circuit 80. In this way, closed circuits are formed on both the first power conversion circuit 30 side and the second power conversion circuit 80 side, causing the primary voltage Vp to rapidly approach zero. In other words, in the Second Embodiment, when switching between the first control and the second control, a period is provided therebetween during which the primary voltage Vp is forcibly reduced to zero. Therefore, it is possible to quickly switch between the first control and the second control, regardless of the on/off states of the switch elements used when switching between the first control and the second control, while reducing the risk of magnetic saturation occurring in transformer 41.
(2-2) In the Second Embodiment, when switching from the first control to the second control, the controller 90 executes the first process prior to the second process in the transition control. In this first process, a closed circuit is formed from the first end of the primary winding 41A to the second end of the primary winding 41A through any one of the plurality of bidirectional switches TSW of the first power conversion circuit 30. Meanwhile, each switch element of the second power conversion circuit 80 is switched to the off state. That is, in the first process, a closed circuit is formed only on the first power conversion circuit 30 side. As a result, in the transition control when switching from the first control to the second control, the primary voltage Vp first approaches zero due to the closed circuit on the first power conversion circuit 30 side. Then, in the subsequent second process, a closed circuit is formed on the second power conversion circuit 80 side. Therefore, at the time when the closed circuit on the second power conversion circuit 80 side is formed, there is a high probability that the primary voltage Vp is zero or close to zero. As a result, at the moment the closed circuit on the second power conversion circuit 80 is formed, it is possible to prevent unintended current from flowing from the primary winding 41A of the transformer 41 to the second power conversion circuit 80.

Furthermore, when switching from the first control to the second control, the controller 90 executes the third process immediately after the second process in the transition control. In this third process, a closed circuit is formed from the first end of the primary winding 41A to the second end of the primary winding 41A through any one of the plurality of switch elements of the second power conversion circuit 80. Meanwhile, each bidirectional switch TSW of the first power conversion circuit 30 is switched to the off state. In this way, by keeping each bidirectional switch TSW of the first power conversion circuit 30 in the off state before the second control, it is possible to prevent current from flowing from the second power conversion circuit 80 to the first power conversion circuit 30 when the second control is started.

While the case of switching from the first control to the second control has been described, when switching from the second control to the first control, the processes in the transition control are executed in the order of the third process, the second process, and the first process. In this case as well, substantially the same effects are achieved as when switching from the first control to the second control.
(2-3) In the Second Embodiment described above, when the phase at the time when the transition control is initiated is within the range of sector 1 or sector 4, the 11th switch element S11, the 21st switch element S21, the 24th switch element S24, and the 14th switch element S14 are switched to the on state. Here, when the first control is being executed and the phase is within the range of sector 1 or sector 4, the absolute value of the first voltage VA is large. From this, it is highly likely that three or more of the four switch elements are in the on state. Therefore, the number of switch elements that are actually switched on or off when turning all four switch elements on can be minimized. The case described above is for when the phase at the time when the transition control is initiated is within the range of sector 1 or sector 4, but the same applies when the phase at the time when the transition control is initiated is within the range of other sectors. Furthermore, when the transition control is executed immediately following the second control, the number of switch elements that are switched on or off when terminating the transition control can be minimized in substantially the same way as described above.

### Modifications

Each of the above embodiments can be implemented with the following modifications. Each of the above embodiments and the following modifications can be combined with each other to the extent that no technical inconsistences arise.

The configuration of the power conversion device 10 is not limited to the examples of the embodiments described above. For example, the power conversion device 10 is not limited to a three-phase isolated AC-DC converter, and can also be applied to a non-isolated three-phase AC-DC converter. Furthermore, the power conversion device 10 does not need to include one or more components selected from the input-side low pass filter 20, the transformer circuit 40, and the rectifier circuit 50. Moreover, the power conversion device 10 may include elements and circuits other than those exemplified in the embodiments described above.

In the First Embodiment, the three-phase AC power supply 100 connected to the three external input terminals is not limited to a three-phase three-wire system, and may also be a three-phase four-wire system or a delta-connected three-phase three-wire system. Similarly, the configuration of the power conversion device 10 may be appropriately changed in accordance with the type of three-phase AC power supply 100.

The input-side low pass filter 20 in each embodiment may include a plurality of capacitors connected between the lines of each phase to which the first voltage VA, the second voltage VB, and the third voltage VC are input.

Each switch element constituting each bidirectional switch TSW is not limited to the examples of the embodiments described above. For instance, the two switch elements in each bidirectional switch TSW may be P-channel MOSFETs. In this case, the drain terminals of the two switch elements of the bidirectional switch TSW are connected to each other.

In each embodiment, the two switch elements of each bidirectional switch TSW may be transistors capable of conducting current in both the forward and reverse directions. In this case, the two switch elements are connected in series with their source terminals connected to each other. Specifically, the switch elements may be gallium nitride high electron mobility transistors (GaN-HEMT), etc.

The transformer circuit 40 in each embodiment does not need to include the fourth inductor L4. In this case, the leakage inductance of the transformer 41 can be used for resonance instead of the fourth inductor L4.

The specific circuit configuration of the rectifier circuit 50 is not limited to the examples in the embodiments described above. For example, the rectifier circuit 50 may be a half-wave rectifier circuit or the like. Also, the rectifier circuit 50 may be a full-bridge circuit consisting of four diodes.

The power conversion device 10 in each embodiment does not need to include the three-phase rectifier circuit 60. For example, a power supply device other than the three-phase AC power supply 100 may be connected to the sixth connection terminal CT6 and the seventh connection terminal CT7 of the booster circuit 70. That is, the fifth capacitor C5 of the second power conversion circuit 80 may be charged by a power supply other than the three-phase AC power supply 100.

The output voltage of the booster circuit 70 in each embodiment may be approximately 283 V or less, which is the voltage input to the first to third input terminals 31A to 31C. Even in this case, the second power conversion circuit 80 can maintain power supply to the load 110 when a momentary power outage occurs. Furthermore, the power conversion device 10 does not need to include the booster circuit 70. In this case, the maximum terminal voltage of the fifth capacitor C5 of the second power conversion circuit 80 is less than or equal to the maximum value of the input voltage of the three-phase AC power. Even in this case, the controller 90 performs the control described in the above embodiments, making it unlikely that an unintended current will flow from the output terminals of the first power conversion circuit 30 to the fifth capacitor C5 of the second power conversion circuit 80.

The power sensor SE in each embodiment may detect the voltage and current values at the first to third external input terminals 31A to 31C of the first power conversion circuit 30, rather than the voltage and current values at the first to third external input terminals 11A to 11C.

The second power conversion circuit 80 of each embodiment may include a switch element connected between the fifth capacitor C5 and the third output terminal 82A and the fourth output terminal 82B. Specifically, the second power conversion circuit 80 may include a switch element connected between the first end of the fifth capacitor C5 and the drain terminal of the first switch element SW1. As a result of the second power conversion circuit 80 including this switch element, it becomes easy to switch between a state in which a voltage is applied to the primary winding 41A from the first power conversion circuit 30 and a state in which a voltage is applied to the primary winding 41A from the second power conversion circuit 80.

In each embodiment, when controlling each bidirectional switch TSW of the first power conversion circuit 30 while switching the switching pattern, the controller 90 does not need to keep all the switch elements of the second power conversion circuit 80 in the off state. For example, two of the switch elements, namely, the second switch element SW2 and the fourth switch element SW4, may be kept in the off state. This configuration of the on/off states of the switch elements is sufficient to prevent current from flowing from the first output terminal 32A and the second output terminal 32B toward the fifth capacitor C5.

In each embodiment, when determining whether the amplitude values of the first to third voltages VA to VC detected by the power sensor SE are less than or equal to the first threshold, it is sufficient for the controller 90 to determine whether the amplitude values are actually less than or equal to the first threshold. For example, if the first threshold is 10 V, it is sufficient to determine that the amplitude values of the input voltages are less than or equal to the first threshold when the first to third voltages VA to VC are −10 V or more and +10 V or less. The same applies to the second threshold.

In the First Embodiment, the controller 90 may switch the plurality of bidirectional switches TSW to the off state and control the plurality of switch elements of the switching circuit BC at a timing other than when the absolute value of the primary voltage Vp becomes less than or equal to the second threshold when the amplitude values of the input voltages input to the plurality of input terminals become less than or equal to the first threshold. Even in such a case, the second power conversion circuit 80 can function as a backup power supply circuit.

In each embodiment, the controller 90 does not need to switch all the bidirectional switches TSW to the off state when the input voltages become less than or equal to the first threshold. The controller 90 may stop power conversion performed by the first power conversion circuit 30 by switching a plurality of bidirectional switches TSW to the off state, and some of the bidirectional switches TSW may remain in the on state.

In each embodiment, when the amplitude values of the plurality of input voltages become less than or equal to the first threshold while the primary voltage Vp is negative, the controller 90 does not need to control the plurality of switch elements so that the primary voltage Vp changes to the positive side when the energy stored in the fifth capacitor C5 begins to be output. That is, in this case, the controller 90 may control the plurality of switch elements so that the primary voltage Vp changes to the negative side when the energy stored in the fifth capacitor C5 begins to be output. The same applies when the amplitude values of the input voltages input to the plurality of input terminals become less than or equal to the first threshold while the primary voltage Vp is positive.

In each embodiment, when the controller 90 is performing control when the amplitude values of the plurality of input voltages are less than or equal to the first threshold, if the amplitude value of one or more input voltages among the plurality of input terminals becomes greater than the first threshold, the controller 90 may switch a plurality of the bidirectional switches TSW to the on state and then control each switch element of the switching circuit BC so that the first output terminal 32A and the second output terminal 32B and the fifth capacitor C5 do not conduct electricity through the switching circuit BC. Even in this case, if the terminal voltage of the fifth capacitor C5 is higher than the maximum value of the input voltage, there is no risk of voltage being applied from the first output terminal 32A and the second output terminal 32B to the fifth capacitor C5.

In the Second Embodiment, it is sufficient that the transition control includes at least the second process. For example, when switching from a state in which the first control is being executed to a state in which the second control is being executed, the controller 90 may omit the first process and the third process and execute only the second process in the transition control. Alternatively, in the transition control, the controller 90 may omit the third process and execute only the first process and the second process, or omit the first process and execute only the second process and the third process. The same applies when switching from a state in which the second control is being executed to a state in which the first control is being executed.

In the Second Embodiment, the controller 90 may execute transition control only when switching from a state in which the first control is being performed to a state in which the second control is being performed, or when switching from a state in which the second control is being performed to a state in which the first control is being performed.

In the transition control of the Second Embodiment, the relationship between the sector range in which the phase lies when the transition control is initiated and the path along which the closed circuit is formed is not considered. For example, the closed circuit may always be formed along the same path, regardless of the sector range in which the phase lies when the transition control is started.

In the transition control of the Second Embodiment, when forming a closed circuit from the first end of the primary winding 41A to the second end of the primary winding 41A through any one of the plurality of bidirectional switches TSW of the first power conversion circuit 30, the combination of on and off states of the switch elements can be changed.

For example, if the phase when transition control is initiated lies within the range of sector 1 or sector 4, the controller 90 may control the 11th switch element S11 and the 14th switch element S14 to be turned on, and the 21st switch element S21 and the 24th switch element S24 to be turned off. Even in this case, current flows through these switch elements via the body diodes of the 21st switch element S21 and the 24th switch element S24. In other words, in the on/off states of these switch elements, a one-way closed circuit is formed that allows current to flow from the second end of the primary winding 41A toward the first end of the primary winding 41A via the four switch elements.

Furthermore, for example, if the phase when the transition control is initiated lies within the range of sector 1 or sector 4, the controller 90 may control the 11th switch element S11 and the 14th switch element S14 to be turned off, and the 21st switch element S21 and the 24th switch element S24 to be turned on. Even in this case, current flows through these switch elements via the body diodes of the 11th switch element S11 and the 14th switch element S14. In other words, in the on/off states of these switch elements, a one-way closed circuit is formed that allows current to flow from the first end of the primary winding 41A toward the second end of the primary winding 41A via the four switch elements.

Although a detailed description will be omitted, even if the phase when the transition control is initiated is within the range of other sectors, the corresponding four switch elements may be controlled in substantially the same manner as in the two modifications described above. In other words, the on/off states of the switch elements may be such that a one-way closed circuit is formed using the body diodes of the switch elements.

In the transition control of the Second Embodiment, when a closed circuit is formed from the first end of the primary winding 41A to the second end of the primary winding 41A via any one of the plurality of switch elements of the second power conversion circuit 80, the on/off combination of the switch elements can be changed.

For example, the controller 90 may switch only the second switch element SW2 to the on state and the other three switch elements to the off state. In this case, current flows through the fourth switch element SW4 via the body diode of the fourth switch element SW4. That is, with the on/off states of these switch elements, a one-way closed circuit is formed that allows current to flow from the first end of the primary winding 41A to the second end of the primary winding 41A via the second switch element SW2 and the fourth switch element SW4. Thus, the on/off states of the switch elements may be such that a one-way closed circuit is formed by utilizing the body diode of each switch element of the second power conversion circuit 80.

Alternatively, for example, the controller 90 may switch the second switch element SW2 and the fourth switch element SW4 to the off state and switch the first switch element SW1 and the third switch element SW3 to the on state.

Furthermore, when forming a closed circuit, it is not necessary to fix the combination of on/off states of the switch elements in this modification, or the combination of on/off states of the switch elements exemplified in the Second Embodiment described above. In other words, the combination of on/off states of the switch elements may be changed each time a closed circuit is formed.

In the Second Embodiment, the controller 90 may perform specific control between the first control and the transition control. In this example, it is assumed that the program PG includes one or more specific switching patterns among the plurality of switching patterns defined as data for the first control. The specific switching pattern is a combination of on/off states of a plurality of bidirectional switches TSW that form a closed circuit from the first end of the primary winding 41A to the second end of the primary winding 41A via any one of the plurality of bidirectional switches TSW of the first power conversion circuit 30.

In this example, the controller 90 controls the on/off state of each bidirectional switch TSW of the first power conversion circuit 30 while switching the switching pattern during the first control. At this time, the controller 90 switches the switching pattern at a timing linked to the magnitude of the input voltages input to the first input terminal 31A, the second input terminal 31B, and the third input terminal 31C. When switching to the second control, the controller 90 performs specific control before executing the transition control.

In the specific control, the controller 90 controls the on/off state of each bidirectional switch TSW of the first power conversion circuit 30 by switching the switching pattern in the same order as in the first control. In addition, the controller 90 basically switches the switching pattern at the same timing as in the first control. However, when the controller 90 controls the on/off state of a plurality of bidirectional switches TSW in accordance with a specific switching pattern, the controller 90 exceptionally maintains the on/off combination of those bidirectional switches TSW for a predetermined period of time or longer, regardless of the magnitude of the input voltage input to each input terminal. This predetermined period can be determined by testing or simulation, for example, as a sufficient time for the primary voltage Vp to reach zero when the above-mentioned closed circuit is formed on the first power conversion circuit 30 side. Furthermore, in the specific control, when the on/off states of a plurality of bidirectional switches TSW according to a specific switching pattern is maintained for a predetermined period of time or longer, the controller controls the on/off states of the bidirectional switches TSW with a switching pattern corresponding to the magnitudes of the input voltages input to the input terminals.

In the example above, when the on/off states of a plurality of bidirectional switches TSW is controlled according to a specific switching pattern in the specific control, the primary voltage Vp becomes zero or close to zero. Subsequently, even if the on/off states of the bidirectional switches TSW are controlled using a switching pattern other than the specific switching pattern in the specific control, the primary voltage Vp does not become significantly larger. In other words, in this example, the primary voltage Vp can be reduced in the specific control before the transition control is executed. Therefore, the likelihood of being able to reduce the primary voltage Vp to zero when the transition control is executed increases.

The classification and naming of the circuit configurations in the above embodiment are for convenience only and are not intended to be limiting. For example, in the above embodiments, the six bidirectional switches TSW are collectively referred to as the “first power conversion circuit 30”, but the embodiments are not limited to this. That is, the six bidirectional switches TSW, along with the transformer circuit 40 and the rectifier circuit 50 in the above embodiments, may be collectively referred to as the “first power conversion circuit”.

### Appendices

Technical concepts that can be understood from each of the above embodiments and the modifications thereof are described below.
[1] A power conversion device including a first power conversion circuit including a plurality of input terminals, a plurality of bidirectional switches, a first output terminal and a second output terminal, and capable of converting three-phase AC power; a transformer including a primary winding and a secondary winding, a first end of the primary winding being connected to the first output terminal and a second end of the primary winding being connected to the second output terminal; a second power conversion circuit including a capacitor, a plurality of switch elements, a third output terminal connected between the first output terminal and the first end of the primary winding, and a fourth output terminal connected between the second output terminal and the second end of the primary winding; and a controller capable of switching the plurality of bidirectional switches and the plurality of switch elements on and off. The second power conversion circuit is capable of outputting energy stored in the capacitor to the third output terminal and the fourth output terminal.
[2] The power conversion device according to [1], wherein the controller executes first control to control the plurality of bidirectional switches so that the first power conversion circuit converts the input voltage and outputs the converted voltage from the first output terminal and the second output terminal when an amplitude value of an input voltage input to one or more of the plurality of input terminals is greater than a predetermined threshold, and executes second control to switch the plurality of bidirectional switches to an off state and to control the plurality of switch elements so that the energy stored in the capacitor is output from the third output terminal and the fourth output terminal to the primary winding when the amplitude value of the input voltage input to the plurality of input terminals becomes less than or equal to the threshold.
[3] The power conversion device according to [2], wherein when the threshold is defined as a first threshold and a potential difference between the first output terminal and the second output terminal is defined as a primary voltage, the controller switches the plurality of the bidirectional switches to the off state and controls the plurality of switch elements so that the energy stored in the capacitor is output to the primary winding when the amplitude value of the input voltage input to the plurality of input terminals becomes less than or equal to the first threshold at a timing when an absolute value of the primary voltage becomes less than or equal to a predetermined second threshold.
[4] The power conversion device according to [3], wherein when the amplitude value of the input voltage input to the plurality of input terminals becomes less than or equal to the first threshold while the primary voltage is negative, the controller switches the plurality of the bidirectional switches to the off state at the timing when the absolute value of the primary voltage becomes less than or equal to the predetermined second threshold, and controls the plurality of switch elements so that the primary voltage changes to positive when the energy stored in the capacitor is output.
[5] The power conversion device according to [4], wherein when the amplitude value of the input voltage input to the plurality of input terminals becomes less than or equal to the first threshold while the primary voltage is positive, the controller switches the bidirectional switches to the off state at a timing when the absolute value of the primary voltage becomes less than or equal to the predetermined second threshold, and controls the plurality of switch elements so that the primary voltage changes to negative when the energy stored in the capacitor is output.
[6] The power conversion device according to any one of [2] to [5], wherein when the plurality of bidirectional switches are in the off state and the controller is controlling the plurality of switch elements, if the amplitude value of the input voltage input to one or more of the plurality of input terminals becomes larger than a predetermined threshold, the controller controls the plurality of switch elements so that the first output terminal and the second output terminal and the capacitor do not conduct electricity through the plurality of switch elements, and then performs control to switch the plurality of bidirectional switches.
[7] The power conversion device according to any one of [1] to [6], wherein the plurality of input terminals are connected to a three-phase AC power supply, the power conversion device further includes a three-phase rectifier circuit that is connected between the three-phase AC power supply and the second power conversion circuit, and is capable of converting input three-phase AC power into DC power and outputting the DC power, and the capacitor is charged by the DC power output by the three-phase rectifier circuit.
[8] The power conversion device according to [7], further including: a booster circuit that is connected between the three-phase rectifier circuit and the second power conversion circuit and boosts a DC voltage output from the three-phase rectifier circuit, wherein an output voltage of the booster circuit is greater than a maximum value of an input voltage input to the input terminals.
[9] The power conversion device according to any one of [2] to [6], wherein the controller performs transition control between the first control and the second control in at least one of a case where switching from a state in which the first control is being performed to a state in which the second control is being performed and a case where switching from a state in which the second control is being performed to a state in which the first control is being performed, and in the transition control, the controller controls on/off states of the plurality of bidirectional switches so as to form a closed circuit from the first end of the primary winding to the second end of the primary winding through any one of the plurality of bidirectional switches, and controls on/off states of the plurality of switch elements so as to form a closed circuit from the first end of the primary winding to the second end of the primary winding through any one of the plurality of switch elements.
[10] The power conversion device according to [9], wherein when the controller switches from the state in which the first control is being performed to the state in which the second control is being performed, the controller performs a first process, a second process, and a third process in this order in the transition control. In the first process, the controller controlling the on/off states of the plurality of bidirectional switches and controlling the plurality of switch elements to the off state so that a closed circuit is formed from the first end of the primary winding to the second end of the primary winding through any one of the plurality of bidirectional switches. In the second process, the controller controlling the on/off states of the plurality of bidirectional switches so that a closed circuit is formed from the first end of the primary winding to the second end of the primary winding through any one of the plurality of bidirectional switches and controlling the on/off states of the plurality of switch elements so that a closed circuit is formed from the first end of the primary winding to the second end of the primary winding through any one of the plurality of switch elements. In the third process, the controller controlling the plurality of bidirectional switches to the off state, and controlling the on/off states of the plurality of switch elements so that a closed circuit is formed from the first end of the primary winding to the second end of the primary winding through any one of the plurality of switch elements.
[11] The power conversion device according to [9] or [10], wherein when the controller switches from the state in which the second control is being performed to the state in which the first control is being performed, the controller performs a third process, a second process, and a first process in this order in the transition control. In the first process, the controller controlling the on/off states of the plurality of bidirectional switches and controlling the plurality of switch elements to the off state so that a closed circuit is formed from the first end of the primary winding to the second end of the primary winding through any one of the plurality of bidirectional switches. In the second process, the controller controlling the on/off states of the plurality of bidirectional switches so that a closed circuit is formed from the first end of the primary winding to the second end of the primary winding through any one of the plurality of bidirectional switches and controlling the on/off states of the plurality of switch elements so that a closed circuit is formed from the first end of the primary winding to the second end of the primary winding through any one of the plurality of switch elements. In the third process, the controller controlling the plurality of bidirectional switches to the off state and controlling the on/off states of the plurality of switch elements so that a closed circuit is formed from the first end of the primary winding to the second end of the primary winding through any one of the plurality of switch elements.
[12] The power conversion device according to any one of [9] to [11], wherein in the first control, the controller controls the on/off states of the plurality of bidirectional switches while switching a switching pattern according to a plurality of different switching patterns defining on/off combinations of the plurality of bidirectional switches. The plurality of switching patterns include a specific switching pattern which is a combination of on/off states of the plurality of bidirectional switches that forms a closed circuit from the first end of the primary winding to the second end of the primary winding through any one of the plurality of bidirectional switches. When the controller switches from the state in which the first control is being performed to the state in which the second control is being performed, the controller performs specific control before performing the transition control. In the specific control, the controller controls the on/off states of the plurality of bidirectional switches while switching the switching patterns in the same order as in the first control, and maintains the combination of on/off states of the plurality of bidirectional switches according to the specific switching pattern for a predetermined period of time or longer, regardless of a magnitude of the input voltage input to the plurality of input terminals.
[13] A power conversion device program to be applied to a power conversion device, the power conversion device including: a first power conversion circuit including a plurality of input terminals, a plurality of bidirectional switches, a first output terminal and a second output terminal, and capable of converting three-phase AC power; a transformer including a primary winding and a secondary winding, a first end of the primary winding being connected to the first output terminal and a second end of the primary winding being connected to the second output terminal; a second power conversion circuit including a capacitor, a plurality of switch elements, a third output terminal connected between the first output terminal and the first end of the primary winding, and a fourth output terminal connected between the second output terminal and the second end of the primary winding; and a controller capable of switching the plurality of bidirectional switches and the plurality of switch elements on and off. The second power conversion circuit is capable of outputting energy stored in the capacitor to the third output terminal and the fourth output terminal. The power conversion device program causes the controller to control the plurality of bidirectional switches so that the first power conversion circuit converts an input voltage and outputs the converted input voltage from the first output terminal and the second output terminal when an amplitude value of the input voltage input to one or more of the plurality of input terminals is greater than a predetermined threshold, and to control the plurality of bidirectional switches to an off state and control the plurality of switch elements so that the energy stored in the capacitor is output to the primary winding from the third output terminal and the fourth output terminal when the amplitude value of the input voltage input to the plurality of input terminals is less than or equal to the threshold.
[14] A power conversion device including a first power conversion circuit including a plurality of input terminals, a first output terminal and a second output terminal, a plurality of bidirectional switches connecting the plurality of input terminals and the first output terminal and the second output terminal, a transformer having a primary winding and a secondary winding, with a first end of the primary winding connected to the first output terminal and a second end of the primary winding connected to the second output terminal, and a rectifier circuit connected to the secondary winding and capable of converting an AC voltage, the first power conversion circuit capable of converting three-phase AC power input to the plurality of input terminals; a second power conversion circuit including a capacitor, a plurality of switch elements, a third output terminal connected between the first output terminal and the first end of the primary winding, and a fourth output terminal connected between the second output terminal and the second end of the primary winding; and a controller capable of switching the plurality of bidirectional switches and the plurality of switch elements on and off. The second power conversion circuit is capable of outputting energy stored in the capacitor to the third output terminal and the fourth output terminal.

What is claimed is:

1. A power conversion device comprising:
a first power conversion circuit including a plurality of input terminals, a plurality of bidirectional switches, a first output terminal and a second output terminal, and being configured to convert three-phase AC power;
a transformer including a primary winding and a secondary winding, a first end of the primary winding being connected to the first output terminal and a second end of the primary winding being connected to the second output terminal;
a second power conversion circuit including a capacitor, a plurality of switch elements, a third output terminal connected between the first output terminal and the first end of the primary winding, and a fourth output terminal connected between the second output terminal and the second end of the primary winding, and the second power conversion circuit being configured to output energy stored in the capacitor to the third output terminal and the fourth output terminal; and
a controller configured to switch the plurality of bidirectional switches and the plurality of switch elements on and off.

2. The power conversion device according to claim 1, wherein
the controller is configured to
execute first control to control the plurality of bidirectional switches so that the first power conversion circuit converts an input voltage and outputs a converted voltage from the first output terminal and the second output terminal when an amplitude value of an input voltage input to one or more of the plurality of input terminals is greater than a predetermined threshold, and
execute second control to switch the plurality of bidirectional switches to an off state and to control the plurality of switch elements so that the energy stored in the capacitor is output from the third output terminal and the fourth output terminal to the primary winding when the amplitude value of the input voltage input to the plurality of input terminals becomes less than or equal to the predetermined threshold.

3. The power conversion device according to claim 2, wherein
when the predetermined threshold is defined as a first threshold and a potential difference between the first output terminal and the second output terminal is defined as a primary voltage,
the controller is configured to switch the plurality of bidirectional switches to an off state and control the plurality of switch elements so that the energy stored in the capacitor is output to the primary winding when the amplitude value of the input voltage input to the plurality of input terminals becomes less than or equal to the first threshold at a timing when an absolute value of the primary voltage becomes less than or equal to a predetermined second threshold.

4. The power conversion device according to claim 3, wherein
when the amplitude value of the input voltage input to the plurality of input terminals becomes less than or equal to the first threshold while the primary voltage is negative, the controller is configured to switch the plurality of bidirectional switches to the off state at the timing when the absolute value of the primary voltage becomes less than or equal to the predetermined second threshold, and control the plurality of switch elements so that the primary voltage changes to positive when the energy stored in the capacitor is output.

5. The power conversion device according to claim 4, wherein
when the amplitude value of the input voltage input to the plurality of input terminals becomes less than or equal to the first threshold while the primary voltage is positive, the controller is configured to switch the plurality of bidirectional switches to the off state at a timing when the absolute value of the primary voltage becomes less than or equal to the predetermined second threshold, and control the plurality of switch elements so that the primary voltage changes to negative when the energy stored in the capacitor is output.

6. The power conversion device according to claim 2, wherein
when the plurality of bidirectional switches are in the off state and the controller is controlling the plurality of switch elements, if the amplitude value of the input voltage input to one or more of the plurality of input terminals becomes larger than a predetermined threshold,
the controller is configured to control the plurality of switch elements so that the first output terminal and the second output terminal and the capacitor do not conduct electricity through the plurality of switch elements, and then performs control to switch the plurality of bidirectional switches.

7. The power conversion device according to claim 1, wherein
the plurality of input terminals are connected to a three-phase AC power supply,
the power conversion device further comprises a three-phase rectifier circuit that is connected between the three-phase AC power supply and the second power conversion circuit, and is configured to convert input three-phase AC power into DC power and outputting the DC power, and
the capacitor is configured to be charged by the DC power output by the three-phase rectifier circuit.

8. The power conversion device according to claim 7, further comprising:
a booster circuit that is connected between the three-phase rectifier circuit and the second power conversion circuit and is configured to boost a DC voltage output from the three-phase rectifier circuit,
wherein an output voltage of the booster circuit is greater than a maximum value of an input voltage input to the plurality of input terminals.

9. The power conversion device according to claim 2, wherein
the controller is configured to perform transition control between the first control and the second control in at least one of a case where switching from a state in which the first control is being performed to a state in which the second control is being performed and a case where switching from a state in which the second control is being performed to a state in which the first control is being performed, and
in the transition control, the controller is configured to
control on/off states of the plurality of bidirectional switches to create a closed circuit from the first end of the primary winding to the second end of the primary winding through any one of the plurality of bidirectional switches, and control the on/off states of the plurality of switch elements to create a closed circuit from the first end of the primary winding to the second end of the primary winding through any one of the plurality of switch elements.

10. The power conversion device according to claim 9, wherein
when the controller switches from the state in which the first control is being performed to the state in which the second control is being performed,
the controller is configured to perform a first process, a second process, and a third process in this order in the transition control,
in the first process, the controller is configured to control the on/off states of the plurality of bidirectional switches and control the plurality of switch elements to the off state so that a closed circuit is created from the first end of the primary winding to the second end of the primary winding through any one of the plurality of bidirectional switches,
in the second process, the controller is configured to control the on/off states of the plurality of bidirectional switches so that a closed circuit is created from the first end of the primary winding to the second end of the primary winding through any one of the plurality of bidirectional switches and control the on/off states of the plurality of switch elements so that a closed circuit is created from the first end of the primary winding to the second end of the primary winding through any one of the plurality of switch elements, and
in the third process, the controller is configured to control the plurality of bidirectional switches to the off state, and control the on/off states of the plurality of switch elements so that a closed circuit is created from the first end of the primary winding to the second end of the primary winding through any one of the plurality of switch elements.

11. The power conversion device according to claim 9, wherein
when the controller is configured to switch from the state in which the second control is being performed to the state in which the first control is being performed,
the controller is configured to perform a third process, a second process, and a first process in this order in the transition control,
in the first process, the controller is configured to control the on/off states of the plurality of bidirectional switches and control the plurality of switch elements to the off state so that a closed circuit is created from the first end of the primary winding to the second end of the primary winding through any one of the plurality of bidirectional switches,
in the second process, the controller is configured to control the on/off states of the plurality of bidirectional switches so that a closed circuit is created from the first end of the primary winding to the second end of the primary winding through any one of the plurality of bidirectional switches and control the on/off states of the plurality of switch elements so that a closed circuit is created from the first end of the primary winding to the second end of the primary winding through any one of the plurality of switch elements, and
in the third process, the controller is configured to control the plurality of bidirectional switches to the off state and control the on/off states of the plurality of switch elements so that a closed circuit is created from the first end of the primary winding to the second end of the primary winding through any one of the plurality of switch elements.

12. The power conversion device according to claim 9, wherein
in the first control, the controller is configured to control the on/off states of the plurality of bidirectional switches while switching a switching pattern according to a plurality of different switching patterns defining on/off combinations of the plurality of bidirectional switches,
the plurality of switching patterns include a specific switching pattern which is a combination of on/off states of the plurality of bidirectional switches that creates a closed circuit from the first end of the primary winding to the second end of the primary winding through any one of the plurality of bidirectional switches,
when the controller switches from the state in which the first control is being performed to the state in which the second control is being performed, the controller is configured to perform specific control before performing the transition control, and
in the specific control, the controller is configured to control the on/off states of the plurality of bidirectional switches while switching the switching patterns in the same order as in the first control, and maintain the combination of on/off states of the plurality of bidirectional switches according to the specific switching pattern for a predetermined period of time or longer, regardless of a magnitude of the input voltage input to the plurality of input terminals.

13. The power conversion device according to claim 3, wherein
when the plurality of bidirectional switches are in the off state and the controller is controlling the plurality of switch elements, if the amplitude value of the input voltage input to one or more of the plurality of input terminals becomes larger than a predetermined threshold,
the controller is configured to control the plurality of switch elements so that the first output terminal and the second output terminal and the capacitor do not conduct electricity through the plurality of switch elements, and then performs control to switch the plurality of bidirectional switches.

14. The power conversion device according to claim 4, wherein
when the plurality of bidirectional switches are in the off state and the controller is controlling the plurality of switch elements, if the amplitude value of the input voltage input to one or more of the plurality of input terminals becomes larger than a predetermined threshold,
the controller is configured to control the plurality of switch elements so that the first output terminal and the second output terminal and the capacitor do not conduct electricity through the plurality of switch elements, and then performs control to switch the plurality of bidirectional switches.

15. The power conversion device according to claim 2, wherein
the plurality of input terminals are connected to a three-phase AC power supply,
the power conversion device further comprises a three-phase rectifier circuit that is connected between the three-phase AC power supply and the second power conversion circuit, and is configured to convert input three-phase AC power into DC power and outputting the DC power, and
the capacitor is configured to be charged by the DC power output by the three-phase rectifier circuit.

16. The power conversion device according to claim 3, wherein
the controller is configured to perform transition control between the first control and the second control in at least one of a case where switching from a state in which the first control is being performed to a state in which the second control is being performed and a case where switching from a state in which the second control is being performed to a state in which the first control is being performed, and
in the transition control, the controller is configured to
control on/off states of the plurality of bidirectional switches to create a closed circuit from the first end of the primary winding to the second end of the primary winding through any one of the plurality of bidirectional switches, and control the on/off states of the plurality of switch elements to create a closed circuit from the first end of the primary winding to the second end of the primary winding through any one of the plurality of switch elements.

17. The power conversion device according to claim 10, wherein
when the controller is configured to switch from the state in which the second control is being performed to the state in which the first control is being performed,
the controller is configured to perform a third process, a second process, and a first process in this order in the transition control,
in the first process, the controller is configured to control the on/off states of the plurality of bidirectional switches and control the plurality of switch elements to the off state so that a closed circuit is created from the first end of the primary winding to the second end of the primary winding through any one of the plurality of bidirectional switches,
in the second process, the controller is configured to control the on/off states of the plurality of bidirectional switches so that a closed circuit is created from the first end of the primary winding to the second end of the primary winding through any one of the plurality of bidirectional switches and control the on/off states of the plurality of switch elements so that a closed circuit is created from the first end of the primary winding to the second end of the primary winding through any one of the plurality of switch elements, and
in the third process, the controller is configured to control the plurality of bidirectional switches to the off state and control the on/off states of the plurality of switch elements so that a closed circuit is created from the first end of the primary winding to the second end of the primary winding through any one of the plurality of switch elements.

18. The power conversion device according to claim 10, wherein
in the first control, the controller is configured to control the on/off states of the plurality of bidirectional switches while switching a switching pattern according to a plurality of different switching patterns defining on/off combinations of the plurality of bidirectional switches,
the plurality of switching patterns include a specific switching pattern which is a combination of on/off states of the plurality of bidirectional switches that creates a closed circuit from the first end of the primary winding to the second end of the primary winding through any one of the plurality of bidirectional switches,
when the controller switches from the state in which the first control is being performed to the state in which the second control is being performed, the controller is configured to perform specific control before performing the transition control, and
in the specific control, the controller is configured to control the on/off states of the plurality of bidirectional switches while switching the switching patterns in the same order as in the first control, and maintain the combination of on/off states of the plurality of bidirectional switches according to the specific switching pattern for a predetermined period of time or longer, regardless of a magnitude of the input voltage input to the plurality of input terminals.

19. A power conversion device program to be applied to a power conversion device, the power conversion device comprising:
a first power conversion circuit including a plurality of input terminals, a plurality of bidirectional switches, a first output terminal and a second output terminal, and configured to convert three-phase AC power;
a transformer including a primary winding and a secondary winding, a first end of the primary winding being connected to the first output terminal and a second end of the primary winding being connected to the second output terminal;
a second power conversion circuit including a capacitor, a plurality of switch elements, a third output terminal connected between the first output terminal and the first end of the primary winding, and a fourth output terminal connected between the second output terminal and the second end of the primary winding; and
a controller configured to switch the plurality of bidirectional switches and the plurality of switch elements on and off, the second power conversion circuit being configured to output energy stored in the capacitor to the third output terminal and the fourth output terminal,
wherein the power conversion device program causes the controller
to control the plurality of bidirectional switches so that the first power conversion circuit converts an input voltage and outputs the converted input voltage from the first output terminal and the second output terminal when an amplitude value of the input voltage input to one or more of the plurality of input terminals is greater than a predetermined threshold, and
to control the plurality of bidirectional switches to an off state and control the plurality of switch elements so that the energy stored in the capacitor is output to the primary winding from the third output terminal and the fourth output terminal when the amplitude value of the input voltage input to the plurality of input terminals is less than or equal to the predetermined threshold.

20. A power conversion device comprising:
a first power conversion circuit including a plurality of input terminals, a first output terminal and a second output terminal, a plurality of bidirectional switches connecting the plurality of input terminals and the first output terminal and the second output terminal, a transformer having a primary winding and a secondary winding, with a first end of the primary winding connected to the first output terminal and a second end of the primary winding connected to the second output terminal, and a rectifier circuit connected to the secondary winding and configured to convert an AC voltage, the first power conversion circuit being configured to convert three-phase AC power input to the plurality of input terminals;
a second power conversion circuit including a capacitor, a plurality of switch elements, a third output terminal connected between the first output terminal and the first end of the primary winding, and a fourth output terminal connected between the second output terminal and the second end of the primary winding; and
a controller configured to switch the plurality of bidirectional switches and the plurality of switch elements on and off, wherein the second power conversion circuit is configured to output energy stored in the capacitor to the third output terminal and the fourth output terminal.
